(19) United States
(12) Patent Application Publication
(10) Pub. No.: US 2014/0115091 A1
(43) Pub. Date: Apr. 24, 2014

(54) MACHINE-IMPLEMENTED FILE SHARING METHOD FOR NETWORK STORAGE SYSTEM

(71) Applicant: APACER TECHNOLOGY INC., Taipei City (TW)

(72) Inventor: Yu-Hsuan Lee, Taipei City (TW)

(73) Assignee: APACER TECHNOLOGY INC., Taipei City (TW)

(21) Appl. No.: 13/837,951

(22) Filed: Mar. 15, 2013

(30) Foreign Application Priority Data
Oct. 19, 2012 (TW) 101138753

(51) Int. Cl. H04L 29/08

(52) U.S. Cl. CPC H04L 29/08117; H04L 29/08549
USPC 709/214

(57) ABSTRACT

A machine-implemented file sharing method for a network storage system is provided. The network storage system at least includes a first storage device, a second storage device and a network cloud. The first storage device and second storage device are in communication with the network cloud. The machine-implemented file sharing method includes the following steps. Firstly, a state of a target file of the second storage device to be retrieved by a user of the first storage device is marked as a freeze state. If it is determined the user of the second storage device is to modify the target file, a file access expediting operation on the target file is performed and a file access notice signal is issued to the user of the first storage device to expedite the retrieval of the target file.

### FIELD OF THE INVENTION

The present invention relates to a machine-implemented file sharing method, and more particularly to a machine-implemented file sharing method for a network storage system.

### BACKGROUND OF THE INVENTION

Recently, the method and device for storing, sharing and playing multimedia files plays a decisive role in the modern life. For constructing an internal storage network in an enterprise, an appropriate storage solution is usually selected to establish an internet-based file storing and sharing system. A widely-used internet-based file storing and sharing system comprises a direct attached storage (DAS) system, a network attached storage (NAS) system, a storage attached network (SAN) system, or the like. Among these internet-based file storing and sharing systems, the network attached storage (NAS) system is a storage system that uses a special file server to directly link to the local area network or the internal network of the enterprise. That is, the NAS system is a file-level computer data storage system that provides access to a group of clients. Since the file server of the NAS system is specially used for accessing data, the other servers of the enterprise are not necessarily responsible for data access and have more capability to process other tasks. Under this circumstance, the functions of the servers are enhanced. Moreover, since the file server of the NAS system is implemented according to the TCP/IP protocol, the NAS system can be operated under the existing network infrastructure without the need of building a new storage infrastructure. Consequently, the NAS servers are gradually adopted by many enterprises.

However, if plural NAS servers are in communication with each other through a network cloud, some drawbacks may occur. For example, when the user of the first NAS server browses the shared contents in the second NAS server and decides to access target content from the second NAS server, the user of the first NAS server may find that the retrieving time is too long because the uplink bandwidth of second NAS server is limited or the size of the target content is too large. In this situation, the user of the first NAS server may not initiate the retrieval at this moment or the user of the first NAS server will come back later to initiate the retrieval from the second NAS server. As time passes, maybe days or weeks later, when user of the first NAS server goes back to access the target content, the target content may have been deleted by owner of the second NAS server. The above situation happens often when we try to access free and public contents in the internet where the contents are controlled by someone else. For example, the popular content hosting websites such as YouTube or Picasa only allow users who are not owners of target contents to browse, view, download or comment on target contents. If an owner of target content decides to delete/remove/modify the content from the website, the users cannot do anything.

Therefore, there is a need of providing an improved machine-implemented file sharing method for a network storage system so as to obviate the above drawbacks.

### SUMMARY OF THE INVENTION

The present invention provides a machine-implemented file sharing method for a network storage system in order to allow the user of the network storage system to retrieve a target file at a later time.

In accordance with an aspect of the present invention, there is provided a machine-implemented file sharing method for a network storage system. The network storage system at least includes a first storage device, a second storage device and a network cloud. The first storage device and second storage device are in communication with the network cloud. The machine-implemented file sharing method includes the following steps. Firstly, a state of a target file of the second storage device to be retrieved by a user of the first storage device is marked as a freeze state. Then, a determining step is performed to determine whether a user of the second storage device is to modify the target file. If it is determined the user of the second storage device is to modify the target file, a file access expediting operation on the target file is performed and a file access notice signal is issued to the user of the first storage device to expedite the retrieval of the target file.

In accordance with another aspect of the present invention, there is provided a machine-implemented file sharing method for a network storage system. The network storage system allows plural users to share files. The machine-implemented file sharing method comprises the following steps. Firstly, the network storage system is configured to allow a first user to mark a target file of a second user as a freeze state. Then, the network storage system is configured to notify the second user that the target file of the second user has been marked as the freeze state before the target file is modified. Thereafter, the network storage system is configured not to modify the target file before a file access expediting operation on the target file is performed.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a network storage system according to an embodiment of the present invention; and

FIG. 2 is a flowchart illustrating a machine-implemented file sharing method for the network storage system of FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

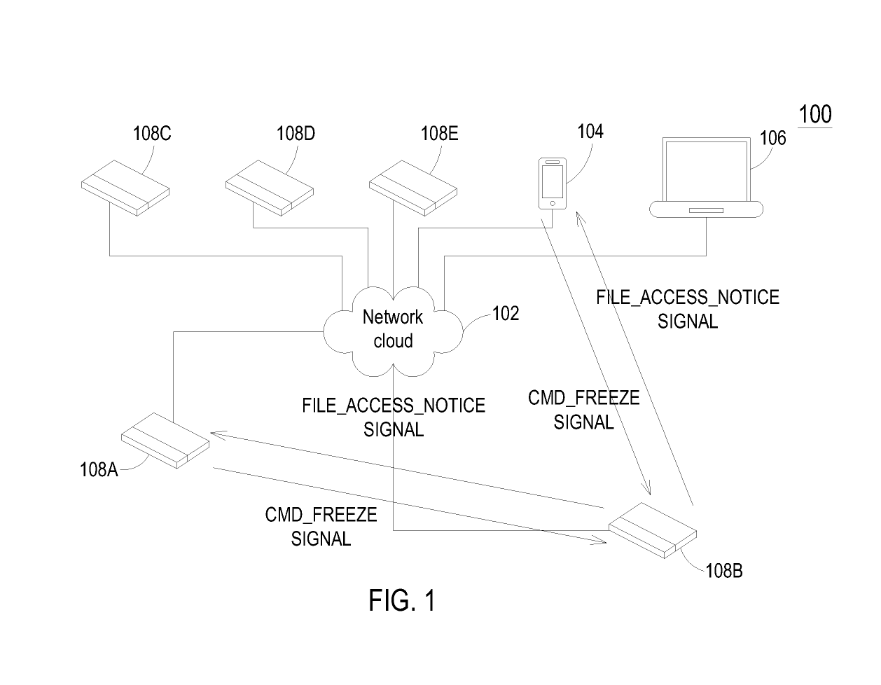

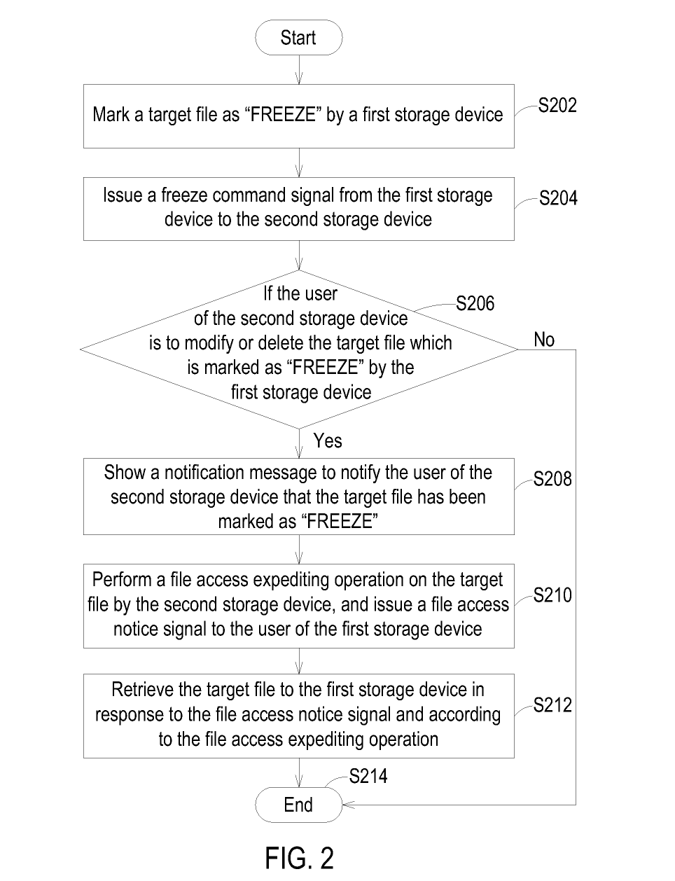

FIG. 1 schematically illustrates the architecture of a network storage system according to an embodiment of the present invention. As shown in FIG. 1, the network storage system 100 comprises a network cloud 102 and plural storage devices. The network cloud 102 comprises a private network cloud server or a public network cloud server. The plural storage devices comprise for example a smart phone 104, a portable computer 106, and plural NAS servers 108A-108E. The smart phone 104, the portable computer 106 and the plural NAS servers 108A-108E may be in communication with each other through the network cloud 102. In this embodiment, the first NAS server 108A, the second NAS server 108B and the third NAS server 108C are also referred as a first storage device, a second storage device and a third storage device, respectively. Moreover, a machine-implemented file sharing method for the network storage system 100 will be illustrated with reference to the flowchart of FIG. 2.

FIG. 2 is a flowchart illustrating a machine-implemented file sharing method for the network storage system of FIG. 1. Please refer to FIGS. 1 and 2. When the user of the first NAS server 108A is interested in a target file stored in second NAS server 108B but chooses to access/view/retrieve at a later time, the user of the first NAS server 108A may mark the target file as “FREEZE” (Step S202). Next, the first NAS server 108A issues a freeze command signal CMD_FREEZE to the second NAS server 108B to inform the second NAS server 108B that the state of the target file has been changed to a freeze state by the user of the first NAS server 108A (Step S204). Then, the step S206 is performed to determine whether the user of the second NAS server 108B is to modify or delete the target file which is marked as “FREEZE” by the first NAS server 108A. If the determining condition of the step 206 is not satisfied, the step S214 is done and the flowchart is ended. If the determining condition of the step S206 is satisfied, a notification message is shown on the second NAS server 108B to notify the user of the second NAS server 108B that the target file has been marked as “FREEZE” by the user of the first NAS server 108A (Step S208). According to the notification message, the second NAS server 108B will perform a file access expediting operation on the target file which is marked as “FREEZE” by the user of the first NAS server 108A, and issues a file access notice signal FILE_ACCESS_NOTICE to the user of the first NAS server 108A (Step S210). In response to the file access notice signal FILE_ACCESS_NOTICE and according to the file access expediting operation of the second NAS server 108B, the first NAS server 108A performs a file retrieving operation to retrieve the target file to the first NAS server 108A (Step S212). After the file retrieving operation is completed, the flowchart is ended (Step S214).

The step S210 of performing the file access expediting operation and issuing the file access notice signal by the second NAS server 108B may be implemented with one of the following approaches:

(a) alerting the first NAS server 108A that the target file will be deleted in a predetermined time (e.g. in three days) by the second NAS server 108B via an email, a short message, an instant message or a built-in communication channel;

(b) alerting the first NAS server 108A that the target file will be deleted in a predetermined time (e.g. in three days) by the second NAS server 108B and the target file will be automatically deleted after the predetermined time via an email, a short message, an instant message or a built-in communication channel;

(c) deleting the target file in the second NAS server 108B now, but alerting the first NAS server 108A that a copy of the target file is available at the third NAS server 108C via an email, a short message, an instant message or a built-in communication channel (namely, notifying the user of the first NAS server 108A the location of the copy of the target file);

(d) duplicating a copy of the target file in the third NAS server 108C, deleting the target file in the second NAS server 108B, and alerting the first NAS server 108A that a retrieving link of the copy of the target file to the third NAS server 108C is provided via an email, a short message, an instant message or a built-in communication channel (namely, notifying the user of the first NAS server 108A the location of the copy of the target file);

(e) duplicating a copy of the target file in the private network cloud server 102, deleting the target file in the second NAS server 108B, and alerting the first NAS server 108A that a retrieving link of the copy of the target file to the private network cloud server 102 is provided via an email, a short message, an instant message or a built-in communication channel (namely, notifying the user of the first NAS server 108A the location of the copy of the target file);

(f) duplicating a copy of the target file in the public network cloud server 102, deleting the target file in the second NAS server 108B, and alerting the first NAS server 108A that a retrieving link of the copy of the target file to the public network cloud server 102 is provided via an email, a short message, an instant message or a built-in communication channel (namely, notifying the user of the first NAS server 108A the location of the copy of the target file);

(g) sending the target file from the second NAS server 108B to the first NAS server 108A right away, and then deleting the target file in the second NAS server 108B;

(h) ignoring the notification message that the target file has been marked in the FREEZE state by the user of the first NAS server 108A, and deleting target file now because the user of the first NAS server 108A is not in the buddy list of the second NAS server 108B.

The step S212 of performing the file retrieving operation to retrieve the target file to the first NAS server 108A by the first NAS server 108A in response to the file access notice signal and according to the file access expediting operation of the second NAS server 108B may be implemented with one of the following approaches:

(a) if the file access expediting operation is performed by the second NAS server 108B with the approach (a) or (b) in the step S210, automatically retrieving the target file from the second NAS server 108B to the first NAS server 108A, or immediately retrieving the target file from the second NAS server 108B to the first NAS server 108A by user's input;

(b) if the file access expediting operation is performed by the second NAS server 108B with the approach (a) or (b) in the step S210, scheduling the first NAS server 108A to automatically retrieve the target file from the second NAS server 108B before the predetermined time;

(c) if the file access expediting operation is performed by the second NAS server 108B with the approach (c), (d), (e) or (f) in the step S210, immediately retrieving the copy of the target file from the third NAS server 108C, the private network cloud server 102 or the public network cloud server 102 to the first NAS server 108A;

(d) if the file access expediting operation is performed by the second NAS server 108B with the approach (c), (d) or (e) in the step S210, marking the copy of the target file stored in the third NAS server 108C or the cloud server 102 as “FREEZE” again by the first NAS server 108A in order to retrieve the target file at a later time.

In some other embodiments, the first NAS server 108A may firstly retrieve only a part of the target file and mark the other part of the target file as “FREEZE” in order to retrieve the other part of target file at a later time. That is, the target file may be retrieved in a batch retrieving manner.

In some other embodiments, the second NAS server 108B may grant the access of the first NAS server 108A to the target file, but deny access of another NAS server which also marks the target file as “FREEZE”.

In some other embodiments, if the first NAS server 108A and the second NAS server 108B are cooperatively operated in a backup mode and the target file in the second NAS server 108B is actually a backup copy of the target file in the first NAS server 108A, the user of the first NAS server 108A may mark the target file in the second NAS server 108B as “FREEZE”, and remove the copy of the target file from the first NAS server 108A in order to increase the storage space of the first NAS server 108A.

In some other embodiments, if the first NAS server 108A and the second NAS server 108B are cooperatively operated in an extended disk mode where the second NAS server 108B functions as an extended disk of the first NAS server 108A, the first NAS server 108A may send the target file originally stored in the first NAS server 108A to the second NAS server 108B, mark the copy of the target file in the second NAS server 108B as “FREEZE”, and remove the target file from the first NAS server 108A in order to increase the storage space of the first NAS server 108A.

In some other embodiments, if the first NAS server 108A has a higher rank than the second NAS server 108B, the second NAS server 108B is not able to ignore notification and modify the target file which is marked as “FREEZE” by the first NAS server 108A unless the first NAS server 108A has retrieved the target file or the first NAS server 108A has de-freeze the target file. Under this circumstance, the second NAS server 108B has to request the first NAS server 108A to expedite its retrieval or to de-freeze the target file.

In some other embodiments, the second NAS server 108B may modify the target file. Consequently, the second NAS server 108B may retain the target file which is marked as “FREEZE” and save the modified version of the target file as a separate file. Alternatively, after the original target file has been retrieved by the first NAS server 108A, the second NAS server 108B may modify the target file and overwrite target file into a new version. In any case, the first NAS server 108 may always get access to the original target file which is marked as “FREEZE”.

However, those skilled in the art will readily observe that numerous modifications and alterations may be made while retaining the teachings of the invention. For example, the smart phone 104 or the portable computer 106 may mark the target file stored in the second NAS server 108B as “FREEZE” in order to retrieve the target file at a later time. As shown in FIG. 1, the operations of the smart phone 104 are similar to those of the first NAS server 108A. That is, the smart phone 104 may mark the target file stored in the second NAS server 108B as “FREEZE” for later retrieval. Moreover, the smart phone 104, the portable computer 106 and the plural NAS servers 108A˜108E may share files via P2P connection. Moreover, the type of the target file is not restricted. For example, the target file may be a text file, an image file, a song file, an audio file, a multimedia file or any other electronic information that can be transmitted through the network. Moreover, the file access notice signal FILE_ACCESS_NOTICE may be firstly issued to the network cloud 102, and then issued to the first NAS server 108A from the network cloud 102.

In some other embodiments, the user may operate an application software (APP) in the smart phone 104 or the portable computer 106 to get access to the network cloud 102 and browse the files owned by another user through a web page interface (not shown) of the network cloud 102, and mark a target file as “FREEZE”. Alternatively, the user may operate the application software (APP) in the smart phone 104 or the portable computer 106 to remotely get access to the storage device of another user and browse the files of the storage device, and mark a target file as “FREEZE”. Alternatively, the user may operate a browser to get access to the web page interface of the network cloud 102 or remotely get access to the storage device of another user in order to perform the above-mentioned machine-implemented file sharing method.

In some embodiments, the user may operate the smart phone 104 to mark a target file as “FREEZE”, operate a desktop computer (not shown) to perform the file access expediting operation, operate a tablet personal computer (not shown) to transmit or receive the file access notice signal, and operate a NAS server to retrieve the target file. For example, the user may get access to the web page interface of the network cloud 102 or remotely get access to the storage device of his own or of another user through an exclusive user account in order to share files. That is, the steps of browsing files, freezing a target file, performing the file access expediting operation, transmitting or receiving the file access notice signal and retrieving the target file may be implemented by different devices. In an embodiment, the steps of browsing files, freezing a target file, performing the file access expediting operation, transmitting or receiving the file access notice signal and retrieving the target file may be operated by the same user. That is, the same user can operate all steps of the machine-implemented file sharing method of the present invention among different devices owned by the same user. From the above discussions, the steps of the machine-implemented file sharing method of the present invention can be separately, partially or completely implemented by device or by user account or a combination thereof. Consequently, the machine-implemented file sharing method of the present invention has enhanced application flexibility.

In accordance with various implementation examples of the present invention, the freezing-side user may operate identical or different local user devices (e.g. desktop computers, notebook computers, tablet personal computers, network storage devices, smart phones or internet-based computing electronic devices) to implement the steps of browsing files, freezing a target file, receiving the file access notice signal and retrieving the target file on remote user devices (e.g. desktop computers, notebook computers, tablet personal computers, network storage devices, smart phones or internet-based computing electronic devices) through a network cloud (e.g. a private network cloud server, a public network cloud server, an internet, a family network, a local area network, an intranet or a P2P network). Similarly, the frozen-side user may operate identical or different local user devices (e.g. desktop computers, notebook computers, tablet personal computers, network storage devices, smart phones or internet-based computing electronic devices) to implement the steps of performing the file access expediting operation and issuing the file access notice signal to remote user devices (e.g. desktop computers, notebook computers, tablet personal computers, network storage devices, smart phones or internet-based computing electronic devices) through a network cloud (e.g. a private network cloud server, a public network cloud server, an internet, a family network, a local area network, an intranet or a P2P network). From the above discussions, the freezing-side user and the frozen-side user may be the same user. Moreover, various steps may be implemented by different user devices.

The machine-implemented file sharing method of the present invention may be applied to the network cloud that provides storage space to the user. For example, the machine-implemented file sharing method of the present invention may be applied to a social networking website that allows the users to share photos, videos, audio files or text messages. In the embodiment where the network storage system is simply the social networking website providing the storage space, the electronic data generated by users are usually stored in the network cloud server of the social networking website instead of the distributed user devices with which users log-in to the social networking website. By operating the above-mentioned user devices to get access to the social networking website, a target electronic data provided by another user of the social networking website may be marked as “FREEZE” by the freezing-side user. When the frozen-side user decides to modify or delete the target electronic data which is marked as the freeze state, the frozen-side user is allowed to implement the steps of performing the file access expediting operation and issuing the file access notice signal through the social networking website, and the freezing-side user is allowed to implement the steps of receiving the file access notice signal and retrieving the target file through the social networking website. In the embodiment of the social networking website, the target file can be various messages that are dispersed through the social networking website. The target file can be photos, videos, audio files, text messages, short messages, comments, published articles, user-related information, or other information that are uploaded and shared by the user. The term “file” or the term “target file” of the present invention can mean information contained in a file form or any digital information in a non-file form (e.g. text messages, short messages, comments, published articles, user-related information).

From the above discussions, a network storage system composed of distributed user devices may be used to implement the step of freezing the file and other steps of various embodiments of the present invention, or a network storage system composed of a centralized social networking website may be used to implement the step of freezing the file and other steps of various embodiments of the present invention.

The machine-implemented file sharing method of the present invention may be applied to a mixed network storage system. A part of the mixed network storage system is the network storage system composed of distributed user devices. Another part of the mixed network storage system is the network storage system composed of a centralized social networking website. That is, a distributed user device is allowed to implement the step of freezing the file and other steps according to embodiments of the present invention on a file stored in the social networking website. Moreover, a user of the social networking website is allowed to implement the step of freezing the file and other steps according to embodiments of the present invention on a file stored in the distributed user device.

From the above descriptions, the present invention provides a machine-implemented file sharing method for a network storage system. The network storage system allows plural users to share files. The machine-implemented file sharing method of the present invention comprises the following steps. Firstly, the network storage system is configured to allow a first user to mark a target file of a second user as a freeze state. Then, the network storage system is configured to notify the second user that the target file of the second user has been marked as the freeze state before the target file is modified. Thereafter, the network storage system is configured not to modify the target file before a file access expediting operation on the target file is performed. Namely, after the target file is marked as “FREEZE” and before the file access expediting operation is performed on the target file, the target file is not allowed to be modified. Consequently, the user can retrieve the original target file to the storage device. The method of performing a file access expediting operation on the target file and the method of issuing a file access notice to the first user have been mentioned in the first embodiments, and are not redundantly described herein.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A machine-implemented file sharing method for a network storage system, said network storage system at least comprising a first storage device, a second storage device and a network cloud, said first storage device and second storage device being in communication with said network cloud, said machine-implemented file sharing method comprising steps of:
(a) changing a state of a target file of said second storage device to be retrieved by a user of said first storage device as a freeze state;
(b) determining whether a user of said second storage device is to modify said target file; and
(c) if it is determined said user of said second storage device is to modify said target file, performing a file access expediting operation on said target file and issuing a file access notice signal to said user of said first storage device to expedite the retrieval of said target file.

2. The machine-implemented file sharing method according to claim 1, wherein each of said first storage device and said second storage device is a network attached storage, a smart phone or a portable computer.

3. The machine-implemented file sharing method according to claim 1, wherein said step (a) comprises sub-steps of:
(a1) operating said first storage device to mark said target file as said freeze state; and
(a2) issuing a freeze command signal from said first storage device to said second storage device, so that said target file is marked as said freeze state in response to said freeze command signal.

4. The machine-implemented file sharing method according to claim 1, further comprising a step (d) of: retrieving said target file to said first storage device in response to said file access notice signal and according to said file access expediting operation of said second storage device.

5. The machine-implemented file sharing method according to claim 4, wherein said step (c) is performed by allowing said second storage device to alert said first storage device that said target file will be deleted in a predetermined time via a communication channel.

6. The machine-implemented file sharing method according to claim 5, wherein said step (d) is performed by scheduling said first storage device to automatically retrieve said target file from said second storage device before said predetermined time.

7. The machine-implemented file sharing method according to claim 4, wherein said step (d) is performed by automatically retrieving said target file from said second storage device to said first storage device or immediately retrieving said target file from said second storage device to said first storage device in response to an input of said user of said first storage device.

8. The machine-implemented file sharing method according to claim 4, wherein said network storage system further comprises a third storage device, and a copy of said target file is stored in the said third storage device, wherein said step (c) is performed by directly deleting said target file in said second storage device and alerting said first storage device that said copy of said target file is stored in the said third storage device via a communication channel.

9. The machine-implemented file sharing method according to claim 8, wherein said step (d) is performed by immediately retrieving said copy of said target file from said third storage device to said first storage device.

10. The machine-implemented file sharing method according to claim 8, wherein said step (d) is performed by marking said copy of said target file in said third storage device as said freeze state and retrieving said target file to said first storage device at a later time.

11. The machine-implemented file sharing method according to claim 4, wherein said network storage system further comprises a third storage device, wherein said step (c) is performed by duplicating a copy of said target file from said second storage device to said third storage device, deleting said target file in said second storage device, and alerting said first storage device that a retrieving link of said copy of said target file to said third storage device is provided via a communication channel.

12. The machine-implemented file sharing method according to claim 11, wherein said step (d) is performed by immediately retrieving said copy of said target file from said third storage device to said first storage device.

13. The machine-implemented file sharing method according to claim 11, wherein said step (d) is performed by marking said copy of said target file in said third storage device as said freeze state and retrieving said target file to said first storage device at a later time.

14. The machine-implemented file sharing method according to claim 4, wherein said network cloud is a private network cloud server, wherein said step (c) is performed by duplicating a copy of said target file from said second storage device to said private network cloud server, deleting said target file in said second storage device, and alerting said first storage device that a retrieving link of said copy of said target file to said private network cloud server is provided via a communication channel.

15. The machine-implemented file sharing method according to claim 14, wherein said step (d) is performed by immediately retrieving said copy of said target file from said private network cloud server to said first storage device.

16. The machine-implemented file sharing method according to claim 14, wherein said step (d) is performed by marking said copy of said target file in said private network cloud server as said freeze state and retrieving said target file to said first storage device at a later time

17. The machine-implemented file sharing method according to claim 4, wherein said network cloud is a public network cloud server, wherein said step (c) is performed by duplicating a copy of said target file from said second storage device to said public network cloud server, deleting said target file in said second storage device, and alerting said first storage device that a retrieving link of said copy of said target file to said public network cloud server is provided via a communication channel.

18. The machine-implemented file sharing method according to claim 17, wherein said step (d) is performed by immediately retrieving said copy of said target file from said public network cloud server to said first storage device.

19. The machine-implemented file sharing method according to claim 17, wherein said step (d) is performed by retrieving said target file from said second storage device to said first storage device in a batch retrieving manner.

20. A machine-implemented file sharing method for a network storage system, said network storage system allowing plural users to share files, said machine-implemented file sharing method comprising steps of:
(a) configuring said network storage system to allow a first user to mark a target file of a second user as a freeze state;
(b) configuring said network storage system to notify said second user that said target file of said second user has been marked as said freeze state before said target file is modified; and
(c) configuring said network storage system not to modify said target file before a file access expediting operation on said target file is performed.

21. The machine-implemented file sharing method according to claim 20, wherein said file access expediting operation is performed by setting a predetermined time and alerting said first user to retrieve said target file before said predetermined time.

22. The machine-implemented file sharing method according to claim 20, wherein said file access expediting operation is performed by setting a predetermined time and automatically modifying said target file after said predetermined time.

23. The machine-implemented file sharing method according to claim 20, wherein said file access expediting operation is performed by notifying said first user of the location of a copy of said target file.

24. The machine-implemented file sharing method according to claim 20, wherein said file access expediting operation is performed by duplicating a copy of said target file to a location and notifying said first user of said location.

25. The machine-implemented file sharing method according to claim 20, wherein said file access expediting operation is performed by directly sending said target file to said first user.

26. The machine-implemented file sharing method according to claim 20, wherein said file access expediting operation is performed by ignoring said freeze state of said target file which is marked by said first user.

27. The machine-implemented file sharing method according to claim 20, further comprising a step of:
(d1) configuring said network storage system to issue a file access notice to said first user, thereby expediting said first user to retrieve said target file.

28. The machine-implemented file sharing method according to claim 20, further comprising steps of:
(d1) configuring said network storage system to issue a file access notice to said first user according to said file access expediting operation; and
(d2) configuring said network storage system to automatically retrieve said target file to said first user according to said file access notice.

29. The machine-implemented file sharing method according to claim 20, further comprising steps of:
(d1) configuring said network storage system to issue a file access notice to said first user according to said file access expediting operation; and
(d2) configuring said network storage system to mark a copy of said target file as said freeze state according to said file access notice.

30. The machine-implemented file sharing method according to claim 20, further comprising a step of:
(d1) configuring said network storage system to delete an existing copy of said target file.

31. The machine-implemented file sharing method according to claim 20, further comprising a step of:
(d1) configuring said network storage system to issue a file access notice to said first user according to said file access expediting operation; and
(d2) configuring said network storage system to allow said target file to be modified after said freeze state is removed according to said file access notice.

32. The machine-implemented file sharing method according to claim 20, wherein said network storage system is composed of distributed user devices, and said target file is stored in a user device of said second user.

33. The machine-implemented file sharing method according to claim 20, wherein said network storage system is a centralized social networking website, and said target file is stored in said centralized social networking website.

34. The machine-implemented file sharing method according to claim 20, wherein each step of said file sharing method can be performed via respective user devices of said first user and said second user.
